(19) United States
(12) Patent Application Publication
(10) Pub. No.: US 2014/0190363 A1
(43) Pub. Date: Jul. 10, 2014

(54) REGISTRATION SYSTEM FOR A VARIABLE REPEAT PRESS

(71) Applicant: GOSS INTERNATIONAL AMERICAS, INC., Durham, NH (US)

(72) Inventors: Glen Roger Caron, Deerfield, NH (US); Brian Joseph Gentle, Rochester, NH (US)

(73) Assignee: GOSS INTERNATIONAL AMERICAS, INC., DURHAM, NH (US)

(21) Appl. No.: 13/734,361

(22) Filed: Jan. 4, 2013

(51) Int. Cl. B41F 13/02

(52) U.S. Cl. CPC B41F 13/025
USPC 101/481

(57) ABSTRACT

A method for phase adjusting a plurality of printing units in a variable format printing press is provided which includes for each of the plurality of printing units (P1 to Pn), determine an angular position (MBPosₓ) of a motor shaft of the motor driving the blanket cylinder of the printing unit when a plate edge of a plate mounted on the plate cylinder of the printing unit is in a nip formed between the plate cylinder and blanket cylinder of the printing unit, and for each of the printing units P2 to Pn, phase adjusting MBPosₓ relative to MBPos₁ so that when edge E1 reaches a nip between the blanket cylinder and impression cylinder of printing unit Px, edge Eₓ is printed on the web. The step of phase adjusting includes calculating a number of stretched images between Px and P1, as a function of a nominal repeat length, a substrate modulus of the web, a web tension, and a distance between printing unit Px and printing unit P1; and based on the calculating step, calculating an phase adjusted angular position PMBPosₓ of the motor shaft of the motor driving the blanket cylinder of the printing unit Px when the motor shaft of the motor driving the blanket cylinder of the printing unit P1 is MBPos₁; and rotating the blanket cylinders to reflect these relative positions.

This application relates to a system and method for setting unit to unit register in a variable repeat printing press.

### BACKGROUND INFORMATION

Variable cut-off or variable format printing presses are known in the art and can accommodate plate (or form) cylinders having different circumferences and associated blanket cylinders having different circumferences. Examples of variable format or variable cut-off presses can be found, for example, in U.S. Pat. No. 5,813,336, incorporated herein by reference.

Unit to unit phasing on a conventional single (fixed) format press is a relatively simple procedure. Print units are rotated manually to predetermined positions that will result in the alignment of all the plate gaps on the printed product. These positions are then mechanically or electrically fixed such that alignment can always be ensured. Once phasing is achieved, full color registration can be maintained with a conventional optical color registration system which detect registration marks on the web or other substrate. Since the format of this type of press is fixed, the phasing procedure can simply be performed once, when the press is initially commissioned.

Variable format presses present a challenge of having to phase a potentially infinite number of formats that exist within the specified repeat range of the press. Many variable format press manufacturers require phasing to be done manually at the start of a new job. This is not only time consuming but can also waste a significant amount of expensive substrate because the operator must print images on the web, observe the misregistration, rotate the cylinders to new positions, and repeat.

### BRIEF SUMMARY OF THE INVENTION

In accordance with a first embodiment of the present invention, a variable format printing press for printing on a web is provided which includes a first printing unit including a first plate cylinder, a first blanket cylinder, and a first impression cylinder, a first motor including a first motor shaft for rotating at least the first blanket cylinder, and a first position sensor for sensing a position of the first motor shaft, the first plate cylinder and first blanket cylinder forming a first nip; a second printing unit downstream of the first printing unit, the second printing unit including a second plate cylinder, a second blanket cylinder, and a second impression cylinder, a second motor including a second motor shaft for rotating at least the second blanket cylinder, and a second position sensor for sensing a position of the second motor shaft, the second plate cylinder and second blanket cylinder forming a second nip; and a third printing unit downstream of the second printing unit, the third printing unit including a third plate cylinder, a third blanket cylinder, and a third impression cylinder, a third motor including a third motor shaft for rotating at least the third blanket cylinder, and a third position sensor for sensing a position of the third motor shaft, the third plate cylinder and third blanket cylinder forming a third nip.

The variable format press further includes a controller coupled to the first, second and third motors and to the first second and third position sensors, the controller including a memory, the memory having stored thereon information sufficient to determine a first angular position of the first motor shaft when a printing plate edge is in the first nip, a second angular position of the second motor shaft when a printing plate edge is in the second nip, and a third angular position of the third motor shaft when a printing plate edge is in the third nip. The controller controls the motors to adjust a phase of the second and third printing unit motors relative to the first printing unit motor as a function of a nominal repeat length of a current format of the printing unit, a web tension of the web, a substrate modulus of the web, and a distance between the first nip and the second nip and a distance between the first nip and the third nip.

In accordance with other further aspects of this embodiment, the controller controls the motors to adjust the phase of the second and third printing unit motors relative to the first printing unit motor by calculating a first number of stretched images between the first nip and the second nip and a second number of stretched images between the first nip and the third nip, and based on the first and second number of stretched images, calculating a phase adjusted angular position of the second motor shaft when the first motor shaft is in the first angular position, and a phased adjusted angular position of the third motor shaft when the first motor shaft is in the first angular position.

In accordance with another aspect of this embodiment, the controller calculates a stretched repeat length R_{stretched}=R[1+(T_{w}/E_{w})], where R is the nominal repeat length, T_{w} is the web tension, and E_{w} is the substrate modulus, and wherein the number of stretched images between the first nip and the second nip is U₁₋₂/R_{stretched}, where U₁₋₂ is the distance between the first nip and the second nip, and wherein the number of stretched images between the first nip and the third nip is U₁₋₃/R_{stretched}, where U₁₋₃ is the distance between the first nip and the third nip.

In accordance with a second embodiment of the present invention, a method for phase adjusting a plurality of printing units (P1 to Pn) in a variable format printing press is provided where each printing unit includes a plate cylinder, a blanket cylinder, and an impression cylinder driven by at least one motor.

The method comprises determining, for each of the printing units P1 to Pn, an angular position (MBPosₓ) of a motor shaft of the motor driving the blanket cylinder of the printing unit when a plate edge of a plate mounted on the plate cylinder of the printing unit is in a nip formed between the plate cylinder and blanket cylinder of the printing unit. In this regard, MBPos₁ is the angular position of the motor shaft of a first printing unit (P1) of the plurality of printing units to print on a web passing sequentially through the plurality of printing units, and MBPosₙ is the angular position of the motor shaft of a last printing unit (Pn) of the plurality of printing units to print on a web passing sequentially through the plurality of printing units. Further, MBPosₓ corresponds to an edge (Eₓ) between successive images printed on the web by printing unit Px. Preferably, a position encoder is associated with each of the motor shafts, and this determining step further comprises resetting each encoder to a count of zero when its associated motor shaft is in position MBPosₓ.

The method further comprises, for each of the printing units P2 to Pn, phase adjusting MBPosₓ relative to MBPos₁ so that when edge E1 reaches a nip between the blanket cylinder and impression cylinder of printing unit Px, edge Eₓ is printed on the web. This step of phase adjusting includes calculating a number of stretched images between Px and P1 as a function of a nominal repeat length, a substrate modulus of the web, a web tension, and a distance between the nip between the blanket cylinder and impression cylinder of printing unit Px and the nip between the blanket cylinder and impression cylinder of printing unit P1; and based on the calculating step, calculating a phase adjusted angular position PMBPosₓ of the motor shaft of the motor driving the blanket cylinder of the printing unit Px when the motor shaft of the motor driving the blanket cylinder of the printing unit P1 is MBPos₁. The method further comprises rotating the motor shafts of the motors driving the blanket cylinders of the printing unit P1 to Pn so that when the motor shaft of the motor driving the blanket cylinder of the printing unit P1 is in position MBPos₁, of the motor shaft of the motor driving the blanket cylinder of the printing unit Pₓ is in position PMBPosₓ, wherein x=2 through n.

In accordance with other aspects of this embodiment, the step of calculating a number of stretched images between Px and P1 as a function of a nominal repeat length, a substrate modulus of the web, a web tension, and a distance between the nip between the blanket cylinder and impression cylinder of printing unit Px and the nip between the blanket cylinder and impression cylinder of printing unit P1, further includes calculating a stretched repeat length R_{stretched}=R[1+(T_{w}/E_{w})], where R is the nominal repeat length, T_{w} is the web tension, and E_{w} is the substrate modulus, and wherein the number of stretched images between Px and P1=U₁₋ₓ/R_{stretched}, where U₁₋ₓ is the distance between between the nip between the blanket cylinder and impression cylinder of printing unit Px and the nip between the blanket cylinder and impression cylinder of printing unit P1.

In accordance with a third embodiment of the present invention, a variable format printing press for printing on a web is provided which includes a first printing unit including a first plate cylinder, a first blanket cylinder, and a first impression cylinder, a first motor including a first motor shaft for rotating at least the first blanket cylinder, and a first position sensor for sensing a position of the first motor shaft, the first plate cylinder and first blanket cylinder forming a first nip; a second printing unit downstream of the first printing unit, the second printing unit including a second plate cylinder, a second blanket cylinder, and a second impression cylinder, a second motor including a second motor shaft for rotating at least the second blanket cylinder, and a second position sensor for sensing a position of the second motor shaft, the second plate cylinder and second blanket cylinder forming a second nip; and a third printing unit downstream of the second printing unit, the third printing unit including a third plate cylinder, a third blanket cylinder, and a third impression cylinder, a third motor including a third motor shaft for rotating at least the third blanket cylinder, and a third position sensor for sensing a position of the third motor shaft, the third plate cylinder and third blanket cylinder forming a third nip.

The variable format press further includes a controller coupled to the first, second and third motors and to the first second and third position sensors, the controller including a memory, the memory having stored thereon information sufficient to determine an first angular position of the first motor shaft when a printing plate edge is in the first nip, a second angular position of the second motor shaft when a printing plate edge is in the second nip, and a third angular position of the third motor shaft when a printing plate edge is in the third nip, the controller controlling the motors to adjust a phase of the second and third motors relative to the first motor as a function of a stretched repeat length of the substrate, a distance between the first nip and the second nip, and a distance between the first nip and the third nip.

### BRIEF DESCRIPTION OF THE DRAWINGS

The present invention will be further described with respect the following Figures, in which:

FIG. 1 illustrates a variable format press in accordance with an embodiment of the present invention.

FIG. 2 shows a detailed view of the second printing unit of the press of FIG. 1.

### DETAILED DESCRIPTION OF PREFERRED EMBODIMENTS OF THE INVENTION

In accordance with the embodiments of the present invention described herein, an automated phase adjustment system is provided for a variable format press.

Although automatic registration systems exist, as discussed above, they are typically only effective to correct small registration errors, for example, cases where the images are within ±0.125″ of each other. In these systems, registration is maintained by monitoring printed images or printed targets on the printed substrate with optical sensors and adjusting the position of the plate and blanket cylinders in each printing unit until registration is achieved. Such an optical automatic registration system is not suitable for a variable format press, where a repeat change significantly different from the previous, registration can be off multiple inches.

Accordingly, for a variable format press, each time a format change exceeds the tolerance of the optical automatic registration system, an operator would print images on the substrate, stop the press, change the phase of the blanket and plate cylinder in each printing unit in view of the observed misregistration in the printed images, and repeat until the registration is within the tolerance of the automatic registration system. This is not only time consuming, but also wastes often expensive substrate.

Therefore, there is a need for a procedure to correctly determine the unit to unit phasing when making a repeat size change in a variable format press. In accordance with the embodiments of the present invention described herein, a procedure is provided which will determine the required print cylinder positions for each unit to achieve registration. This can accomplished automatically, and without printing on the substrate. This provides nearly instantaneous registration without any wasted substrate.

Preferably, the registration method in accordance with the embodiments of the present invention is used in conjunction with a conventional automatic registration system so that once the phasing is within the necessary range of an automatic registration control system (e.g. within ±0.125″) a conventional automatic registration control system completes the registration process.

In accordance with the registration method in accordance with an embodiment of the present invention, the blanket and plate drive motors are first “zeroed” in a predetermined cylinder orientation to calculate proper unit to unit phasing. This zeroing is performed so that the position of the plate edge will correspond to the same motor count value for every printing unit of the press. In presses where the plate cylinder gap is at the same angular position for every format (e.g. through the use of registration pins), this can be done during press installation. In any case, this can also be performed at any time using, for example, a gauge or by visually aligning the plate cylinder gap with a known position of the motor, and setting that position as the zero position. In any event, what is important is for the system to have a fixed known relationship with between the edge of the plate and the position of the motor(s) for the plate and blanket cylinders in each printing unit for use in the registration method.

The following inputs are used to correctly determine the proper motor position for each unit: (i) desired repeat size, (ii) substrate modulus, (iii) web tension, and the (iv) span length between each unit. From these inputs the stretched repeat length can be calculated. With this information, the number of stretched images can be calculated between units. Once the number of stretched images is determined, the angle of the blanket cylinder from the nip with the impression cylinder to the end of the image can be calculated.

All downstream printing units of the press are phased to the first unit. Therefore, the first unit will be set to 0 for the motor count phasing. For the remaining units the motor count position can be calculated from the known blanket cylinder position that was previously calculated.

Although the process as described above involves zeroing the blanket cylinder motors and the plate cylinder motors, unit to unit phasing can still be calculated even if the zeroing of the blanket motors has not been done. However, in that case it is necessary to know the motor positions for perfect registration for one repeat. In other words, once registration has been achieved for one format, the relationship between the motor position and the calculations are the same as above except the difference between blanket cylinder positions between the known repeat and the new repeat are determined.

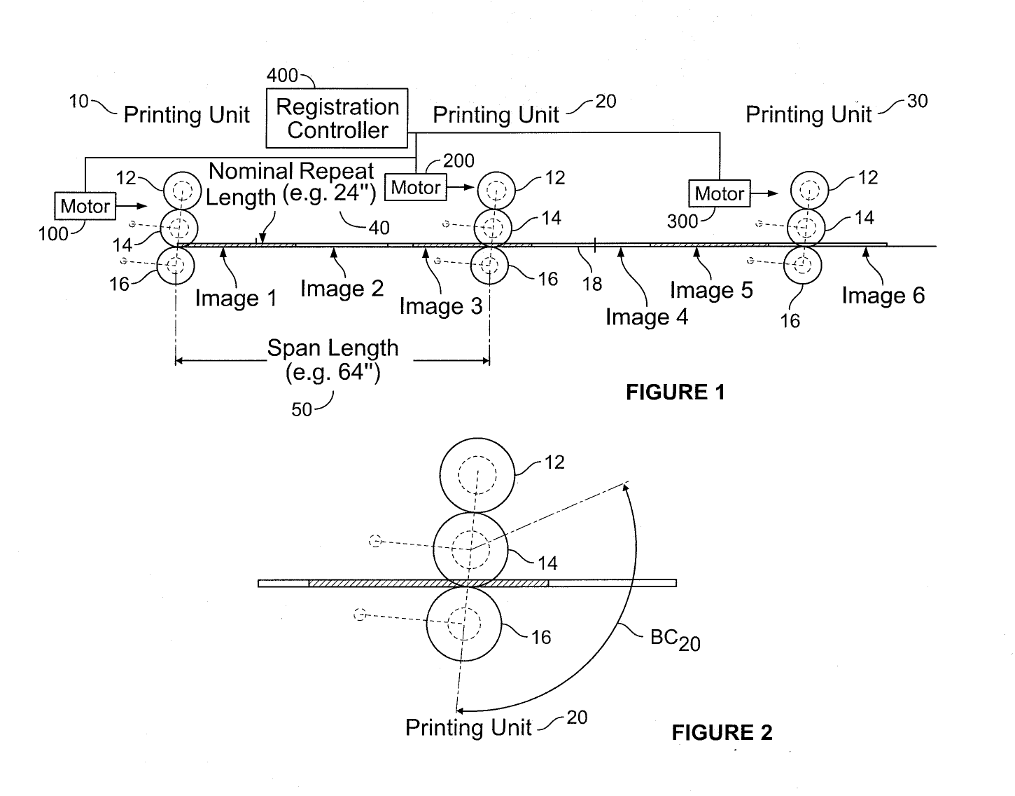

FIG. 1 schematically illustrates a variable format printing press 100 including a first printing unit 10, a second printing unit 20, and a third printing unit 30. Each printing unit includes a plate cylinder 12, a blanket cylinder 14, and an impression cylinder 16. The cut-off or format, of the press can be changed by changing the plate cylinder and blanket cylinders to a different sized diameter (and thus circumference) plate cylinder and blanket cylinder. Each printing unit may print a different color on a substrate or web 18.

Initially, we note that in each printing unit, the plate and blanket cylinders 12, 14 are rotated together for purposes of phase adjustment, and may be driven either by a common motor or by separates motors that are electronically synchronized. If the press is constructed as a shaftless press, these motors may also drive the plate and blanket cylinders during a printing operation. Alternatively, if the press is a line shaft driven press, the motors may be used only for phase adjustment, and/or for other make-ready procedures.

In order to provide registration for the printing press 100, an initial position of the plate and blanket cylinders 12, 14 is determined, and set as the zero position of the motor. As explained above, this can be determined during installation or at any later date, and may be determined through the use of gauges, optical sensors, or even by visual alignment.

Additional information used as input to the registration method is: (i) desired repeat size, (ii) substrate modulus, (iii) web tension, and the (iv) span length between each unit. The desired nominal repeat size R is the circumferential length of the plate on the plate cylinder. This is often called the “cut-off” or “format” of the press. In the example discussed below, we will use a repeat size or cut-off of 24 inches. The substrate modulus, E_{w} is a characteristic of the substrate used, and is expressed in lbf/in. In our example, E_{w}=218 lbf/in. The term substrate modulus, as used herein, is defined as the elastic modulus of the substrate multiplied by the thickness of the substrate. The web tension, Tw, expressed in lbf/in, is a monitored parameter of the press. As one of ordinary skill in the art will appreciate, in a web fed printing press it is conventional to monitor the tension in the web. This monitored value, or a set-point (or desired) value, is used. In this example, we will use a setpoint value of Tw=1.31 lbf/in. The span length (U) is the distance between the nip of one printing unit and the nip of the next adjacent printing unit. In our example, eight printing units are equally spaced apart at 64.518 inches.

Using this information, a stretched repeat length R_{stretched} is calculated. As one of ordinary skill in the art will appreciate, the actual length of a printed image passing through a web press will be greater than the nominal repeat size due the substrate modulus of the web and the web tension. As used herein, the term stretched repeat length means the repeat length of the printed substrate passing through a web press under tension. In this regard the stretched repeat length may be calculated as R_{stretched}=R[1+(T_{w}/E_{w})], which in our example is R_{stretched}=24.1442 inches.

Using the stretched repeat length, the number of images between the first printing unit and printing unit x is determined for the eight printing units in our example:

$$\begin{matrix}\text{?} = \frac{\text{?}}{\text{?}} & \text{?} \\ \text{?} = \frac{\text{?}}{\text{?}} & \text{?} \\ \text{?} \frac{\text{?}}{\text{?}} & \text{?} \\ \text{?} \frac{\text{?}}{\text{?}} & \text{?} \\ \text{?} \frac{\text{?}}{\text{?}} & \text{?} \\ \text{?} \frac{\text{?}}{\text{?}} & \text{?} \\ \text{?} \frac{\text{?}}{\text{?}} & \text{?}\end{matrix}$$

$$\text{?} \text{indicates text missing or illegible when filed}$$

With these values N₁₋ₓ, we can calculate the blanket cylinder position of unit X after a complete image is printed:
BC₂=360 deg*(ceil(N₁_{_{—}}₂)−N₁_{_{—}}₂) BC₂=118.0108 deg
BC₃=360 deg*(ceil(N₁_{_{—}}₃)−N₁_{_{—}}₃) BC₃=236.0215 deg
BC₄=360 deg*(ceil(N₁_{_{—}}₄)−N₁_{_{—}}₄) BC₄=354.0323 deg
BC₅=360 deg*(ceil(N₁_{_{—}}₅)−N₁_{_{—}}₅) BC₅=112.043 deg
BC₆=360 deg*(ceil(N₁_{_{—}}₆)−N₁_{_{—}}₆) BC₆=230.0538 deg
BC₇=360 deg*(ceil(N₁_{_{—}}₇)−N₁_{_{—}}₇) BC₇=348.0646 deg
BC₈=360 deg*(ceil(N₁_{_{—}}₈)−N₁_{_{—}}₈) BC₈=106.0753 deg
   wherein the function “ceil(x)” returns the smallest integer greater than or equal to x. FIG. 2 shows the angle BC₂=118.0108 degrees.

With this information, the motor position for each blanket cylinder M_{BC}_{_{—}}ₓ can be calculated as follows:

| | | |
|---|---|---|
| M_{BC}_{_{—}}_{U1} = 0 | M_{BC}_{_{—}}_{U1} = 0000000 | Motor count for |
| | | unit 1 |
| M_{BC}_{_{—}}_{U2} = (B_{C2}/360 deg) * M_{c} | M_{BC}_{_{—}}_{U2} = 1180108 | Motor count for |
| | | unit 2 |
| M_{BC}_{_{—}}_{U3} = (B_{C3}/360 deg) * M_{c} | M_{BC}_{_{—}}_{U3} = 2360215 | Motor count for |
| | | unit 3 |
| M_{BC}_{_{—}}_{U4} = (B_{C4}/360 deg) * M_{c} | M_{BC}_{_{—}}_{U4} = 3540323 | Motor count for |
| | | unit 4 |
| M_{BC}_{_{—}}_{U5} = (B_{C5}/360 deg) * M_{c} | M_{BC}_{_{—}}_{U5} = 1120430 | Motor count for |
| | | unit 5 |
| M_{BC}_{_{—}}_{U6} = (B_{C6}/360 deg) * M_{c} | M_{BC}_{_{—}}_{U6} = 2300538 | Motor count for |
| | | unit 6 |
| M_{BC}_{_{—}}_{U7} = (B_{C7}/360 deg) * M_{c} | M_{BC}_{_{—}}_{U7} = 3480646 | Motor count for |
| | | unit 7 |
| M_{BC}_{_{—}}_{U8} = (B_{C8}/360 deg) * M_{c} | M_{BC}_{_{—}}_{U8} = 1060753 | Motor count for |
| | | unit 8 |

where M_{c} is the motor counts per cylinder revolution, in our example: 3,600,000. If unit 1 is set to any value other than zero, then the motor count is offset by that amount. For example, if the motor count of unit 1 is 10 when the plate edge is in the nip as shown in FIG. 1, then MBC_{—}1=10, and M_{BC}_{_{—}}_{U2}=(B_{C2}/360 deg)*M_{c}+10, etc.

Referring to FIG. 1, a registration controller 400 executes the above process. Controller 400 may be a computer executing software, but alternative could be an ASIC, state machine, FPGA or other non-software based controller. Controller 400 may include memory to store the information needed to perform the calculations discussed above, regardless of whether it is implemented with software. Controller 400 also may be a standalone controller, or may form part of the overall press control system. Controller 400 adjusts the motor position of each blanket cylinder 14 through motor 300. In addition, the position of motor 100, 200, 300 is monitored via an encoder or resolver. In our example, this would be a 3,600,000 count encoder or resolver. During the zeroing process described above, with the plate and blanket cylinder in each printing unit positioned so that the plate cylinder gap is at the nip, the controller sets each encoder or resolver to a count of zero. It should be noted that although it is typically simpler to set the counter to zero when the plate cylinder gap is in the nip, this is not strictly necessary. What is important is that, for each encoder, the system knows the relationship between the count of the encoder and the angular position of its associated cylinder.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A variable format printing press for printing on a web, comprising
a first printing unit including a first plate cylinder, a first blanket cylinder, and a first impression cylinder, a first motor including a first motor shaft for rotating at least the first blanket cylinder, and a first position sensor for sensing a position of the first motor shaft, the first plate cylinder and first blanket cylinder forming a first nip;
a second printing unit downstream of the first printing unit, the second printing unit including a second plate cylinder, a second blanket cylinder, and a second impression cylinder, a second motor including a second motor shaft for rotating at least the second blanket cylinder, and a second position sensor for sensing a position of the second motor shaft, the second plate cylinder and second blanket cylinder forming a second nip;
a third printing unit downstream of the second printing unit, the third printing unit including a third plate cylinder, a third blanket cylinder, and a third impression cylinder, a third motor including a third motor shaft for rotating at least the third blanket cylinder, and a third position sensor for sensing a position of the third motor shaft, the third plate cylinder and third blanket cylinder forming a third nip;
a controller coupled to the first, second and third motors and to the first second and third position sensors, the controller including a memory, the memory having stored thereon information sufficient to determine a first angular position of the first motor shaft when a printing plate edge is in the first nip, a second angular position of the second motor shaft when a printing plate edge is in the second nip, and a third angular position of the third motor shaft when a printing plate edge is in the third nip, the controller controlling the motors to adjust a phase of the second and third motors relative to the first motor as a function of a nominal repeat length of a current format of the printing unit, a web tension of the web, a substrate modulus of the web, and a distance between the first nip and the second nip and a distance between the first nip and the third nip.

2. The press of claim 1, wherein the controller controls the motors to adjust the phase of the second and third motors relative to the first motor by calculating a first number of stretched images between the first nip and the second nip and a second number of stretched images between the first nip and the third nip, and based on the first and second number of stretched images, calculating a phase adjusted angular position of the second motor shaft when the first motor shaft is in the first angular position, and a phased adjusted angular position of the third motor shaft when the first motor shaft is in the first angular position.

3. The printing press of claim 2, wherein the controller calculates a stretched repeat length R_{stretched}=R[1+(T_{w}/E_{w})], where R is the nominal repeat length, T_{w} is the web tension, and E_{w} is the substrate modulus, and wherein the number of stretched images between the first nip and the second nip is U₁₋₂/R_{stretched}, where U₁₋₂ is the distance between the first nip and the second nip, and wherein the number of stretched images between the first nip and the third nip is U₁₋₃/R_{stretched}, where U₁₋₃ is the distance between the first nip and the third nip.

4. A method for phase adjusting a plurality of printing units (P1 to Pn) in a variable format printing press, each printing unit including a plate cylinder, a blanket cylinder, and an impression cylinder driven by at least one motor, the method comprising:
for each of the printing units P1 to Pn, determine an angular position (MBPosₓ) of a motor shaft of the motor driving the blanket cylinder of the printing unit when a plate edge of a plate mounted on the plate cylinder of the printing unit is in a nip formed between the plate cylinder and blanket cylinder of the printing unit, where MBPos₁ is the angular position of the motor shaft of a first printing unit (P1) of the plurality of printing units to print on a web passing sequentially through the plurality of printing units, and MBPosₙ is the angular position of the motor shaft of a last printing unit (Pn) of the plurality of printing units to print on the web passing sequentially through the plurality of printing units, wherein MBPosₓ corresponds to an edge (Eₓ) between successive images printed on the web by printing unit Px;
for each of the printing units P2 to Pn, phase adjusting MBPosₓ relative to MBPos₁ so that when edge E1 reaches a nip between the blanket cylinder and impression cylinder of printing unit Px, edge Eₓ is printed on the web, the step of phase adjusting including
calculating a number of stretched images between Px and P1, as a function of a nominal repeat length, a substrate modulus of the web, a web tension, and a distance between the nip between the blanket cylinder and impression cylinder of printing unit Px and the nip between the blanket cylinder and impression cylinder of printing unit P1;
based on the calculating step, calculating a phase adjusted angular position PMBPosₓ of the motor shaft of the motor driving the blanket cylinder of the printing unit Px when the motor shaft of the motor driving the blanket cylinder of the printing unit P1 is MBPos₁;
rotating the motor shafts of the motors driving the blanket cylinders of the printing unit P1 to Pn so that when the motor shaft of the motor driving the blanket cylinder of the printing unit P1 is in position MBPos₁, the motor shaft of the motor driving the blanket cylinder of the printing unit Pₓ is in position PMBPosₓ, wherein x=2 through n.

5. The method of claim 4, wherein the step of calculating a number of stretched images between Px and P1 as a function of a nominal repeat length, a substrate modulus of the web, a web tension, and a distance between the nip between the blanket cylinder and impression cylinder of printing unit Px and the nip between the blanket cylinder and impression cylinder of printing unit P1, further includes calculating a stretched repeat length R_{stretched}=R[1+(T_{w}/E_{w})], where R is the nominal repeat length, T_{w} is the web tension, and E_{w} is the substrate modulus, and wherein the number of stretched images between Px and P1=U₁₋ₓ/R_{stretched}, where U₁₋ₓ is the a distance between the nip between the blanket cylinder and impression cylinder of printing unit Px and the nip between the blanket cylinder and impression cylinder of printing unit P1, wherein x=2 through n.

6. The method of claim 4, wherein the step of determining an angular position MBPosₓ is performed using a guage.

7. The method of claim 4, wherein a position encoder is associated with each of the motor shafts, and wherein the determining step further comprises resetting each encoder to a count of zero when its associated motor shaft is in position MBPosₓ, wherein x=1 through n.

8. A variable format printing press for printing on a web, comprising
a first printing unit including a first plate cylinder, a first blanket cylinder, and a first impression cylinder, a first motor including a first motor shaft for rotating at least the first blanket cylinder, and a first position sensor for sensing a position of the first motor shaft, the first plate cylinder and first blanket cylinder forming a first nip;
a second printing unit downstream of the first printing unit, the second printing unit including a second plate cylinder, a second blanket cylinder, and a second impression cylinder, a second motor including a second motor shaft for rotating at least the second blanket cylinder, and a second position sensor for sensing a position of the second motor shaft, the second plate cylinder and second blanket cylinder forming a second nip;
a third printing unit downstream of the second printing unit, the third printing unit including a third plate cylinder, a third blanket cylinder, and a third impression cylinder, a third motor including a third motor shaft for rotating at least the third blanket cylinder, and a third position sensor for sensing a position of the third motor shaft, the third plate cylinder and third blanket cylinder forming a third nip;
a controller coupled to the first, second and third motors and to the first second and third position sensors, the controller including a memory, the memory having stored thereon information sufficient to determine an first angular position of the first motor shaft when a printing plate edge is in the first nip, a second angular position of the second motor shaft when a printing plate edge is in the second nip, and a third angular position of the third motor shaft when a printing plate edge is in the third nip, the controller controlling the motors to adjust a phase of the second and third motors relative to the first motor as a function of a stretched repeat length of the substrate, a distance between the first nip and the second nip, and a distance between the first nip and the third nip.

9. The printing press of claim 8, wherein the stretched repeat length of the substrate is calculated by the controller as a function of a nominal repeat length of a current format of the printing unit, a web tension of the web, and a substrate modulus of the web.

10. The press of claim 9, wherein the controller controls the motors to adjust the phase of the second and third motors relative to the first motor by calculating a first number of stretched images between the first nip and the second nip and a second number of stretched images between the first nip and the third nip, and based on the first and second number of stretched images, calculating a phase adjusted angular position of the second motor shaft when the first motor shaft is in the first angular position, and a phased adjusted angular position of the third motor shaft when the first motor shaft is in the first angular position.

11. The printing press of claim 10, wherein the controller calculates a stretched repeat length R_{stretched}=R[1+(T_{w}/E_{w})], where R is the nominal repeat length, T_{w} is the web tension, and E_{w} is the substrate modulus, and wherein the number of stretched images between the first nip and the second nip is U₁₋₂/R_{stretched}, where U₁₋₂ is the distance between the first nip and the second nip, and wherein the number of stretched images between the first nip and the third nip is U₁₋₃/R_{stretched}, where U₁₋₃ is the distance between the first nip and the third nip.
